(19) United States
(12) Patent Application Publication
(10) Pub. No.: US 2013/0079905 A1
(43) Pub. Date: Mar. 28, 2013

(54) Human-Operated Working Machine System

(71) Applicants: Makoto Saen, Kodaira (JP); Kiyoto Ito, Kodaira (JP)

(72) Inventors: Makoto Saen, Kodaira (JP); Kiyoto Ito, Kodaira (JP)

(73) Assignee: HITACHI, LTD., Chiyoda-ku, Tokyo (JP)

(21) Appl. No.: 13/701,391

(22) PCT Filed: Jun. 3, 2010
(86) PCT No.: PCT/JP2010/059470

§ 371 Date: Nov. 30, 2012

(51) Int. Cl. G05B 15/02

(52) U.S. Cl. CPC G05B 15/02
USPC 700/83

(57) ABSTRACT

In a human-operated working machine system made up of a working machine including an actuator and an operating device, various operations for target objects having various hardnesses and shapes are achieved at a speed not giving stress to an operator. To this end, the working machine has a control structure in which a control program corresponding to an action content is executed with both of displacement information with respect to the working machine inputted from the operating device and information from a sensor of the working machine being taken as inputs. Furthermore, the operating device has a simulator that predicts an action of the working machine so as to quickly provide image information and tactile information regarding the action of the working machine to the operator.

### TECHNICAL FIELD

The present invention relates to a working machine system having a working machine including an actuator (movable unit) and an operating device for a person operating the working machine.

### BACKGROUND ART

A working machine system including an actuator has been used mainly for assembling and others at production sites, and is expected to be used in the future also to help human activities at public facilities such as hospitals and living spaces such as home. Among the working machines for work in a living space, the present invention particularly relates to a human-operated working machine system for a living space including a working machine and an operating device.

For making this human-operated system useful, it is indispensable to achieve the operational feeling that can make a person perform a work smoothly. For this purpose, the working machine is required to operate at a speed with which an operator does not feel stress, and the operation results are required to be presented to the operator at a delay time with which the operator does not feel stress.

In Patent Document 1, the operating device to be operated by the operator and the working machine are positioned away from each other, and means for shortening a time from the time when an input to the operating device is made until the time when the operating device outputs image information representing a working situation on a working machine side to the operator is described. To conceal a communication time between the operating device and the working machine and quickly present the image information to the operator, the operating device has a simulator that synthesizes and generates image information in consideration of an operation input.

### PRIOR ART DOCUMENTS

### Patent Documents

Patent Document 1: Japanese Unexamined Patent Application Publication No. H01-271185

### SUMMARY OF THE INVENTION

### Problems to be Solved by the Invention

In the method described in Patent Document 1, it is thought to be difficult to operate the working machine at a speed with which the operator does not feel stress in the use in a living space. This is because since delicate operations such as handling target objects with various hardnesses and shapes and complex actions are required in the use in a living space and it is difficult to present minutely accurate information important therefor to the operator, fine control of power and position from the operating device cannot be performed at a sufficient speed.

An object of the present invention is to achieve various operations for target objects with various hardnesses and shapes at a speed with which the operator does not feel stress in the human-operated working machine.

### Means for Solving the Problems

The following is a brief description of an outline of the typical invention disclosed in the present application.

A working machine has a plurality of control programs in accordance with action contents, and executes a control program corresponding to an action content specified by an operating device by using both of physical information such as displacement information inputted from the operating device and information from a sensor included in the working machine as input information. This working machine system has a two-step control structure in which an operator makes an instruction about an action content and a rough shape of the working machine and the working machine autonomously performs delicate power control and fine positional adjustment. In this manner, the operator can achieve a delicate operation even if the operator does not have detailed information for the delicate control.

Furthermore, the operating device has a simulator that predicts an action of the working machine, and it provides tactile information or the like to the operator based on an output from the simulator. In this manner, information can be provided to the operator without communication delay between the operating device and the working machine and process delay in the working machine, and the operational stress can be reduced.

### Effects of the Invention

In a human-operated working machine, a smooth operation with small operator's stress can be achieved.

### BRIEF DESCRIPTIONS OF THE DRAWINGS

FIG. 1 is a diagram for describing a configuration of a human-operated working machine system;

FIG. 2 is a diagram for describing a structure of a working machine ACT;

FIG. 3 is a diagram for describing an operation interface unit UIDP;

FIG. 4 is a diagram for describing an operation interface unit UIPS;

FIG. 5 is a diagram for describing a configuration of a control unit of a working machine;

FIG. 6 is a diagram for describing a process flow of the working machine;

FIG. 7 is a diagram for describing a process flow of the working machine;

FIG. 8 is a diagram for describing a configuration of a control unit of the working machine;

FIG. 9 is a diagram for describing a configuration of a semiconductor chip constituting the working machine;

FIG. 10 is a diagram for describing an operation simulator of the operating device; and

FIG. 11 is an example of a table retaining action target values and restriction values of a movable unit.

### BEST MODE FOR CARRYING OUT THE INVENTION

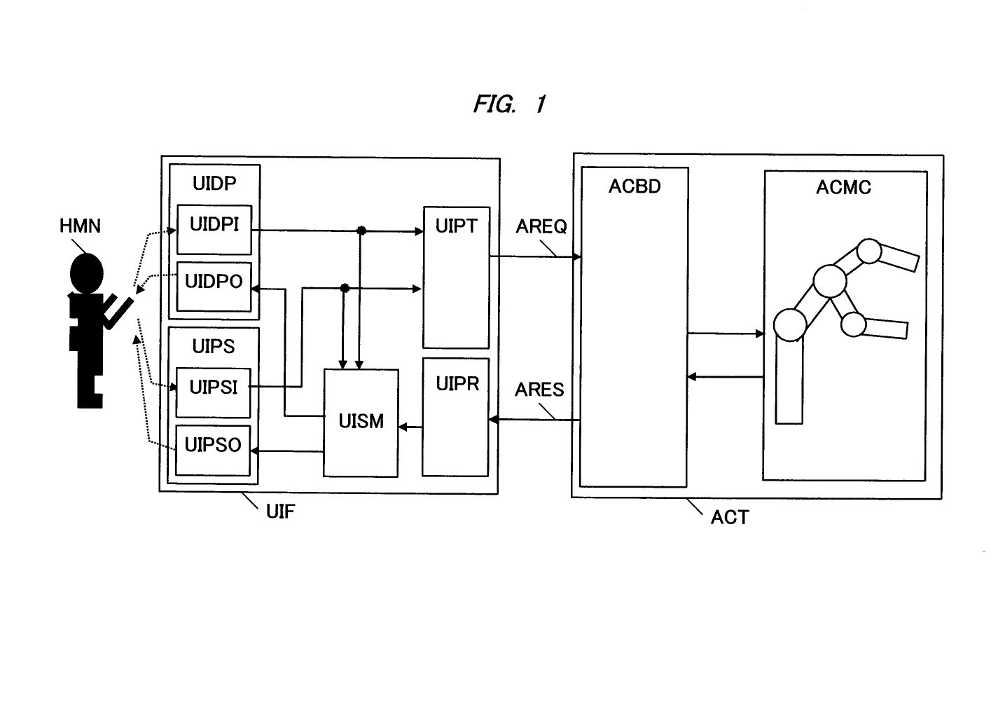

FIG. 1 shows one embodiment of the configuration of a human-operated working machine system. This working machine system includes a working machine ACT including an actuator and an operating device UIF for an operator HMN performing operations on the working machine. The working machine has a working machine movable unit ACMC including the actuator and a sensor and a working machine control unit ACBD for controlling the movable unit ACMC. On the other hand, the operating device has an operation interface unit UIDP of a display type, an operation interface unit UIPS such as a motion capture, a transmitting unit UIPT transmitting operation instruction information AREQ from the operation interface units UIDP and UIPS to the working machine, a receiving unit UIPR receiving response information ARES such as image information from the working machine, and an operation simulator UISM for returning an operation response such as images and tactile information on a working machine side to the operator HMN in a small delay time. The operation simulator UISM has a function of performing a predictive simulation of actions on a working machine side, and as will be described further below, it is particularly effective when the working machine ACT is controlled from the operating device UIF located at a remote place. Also, the operation interface units UIDP and UIPS include parts UIDPI and UIPSI to which the operator provides an input for the working machine and parts UIDPO and UIPSO from which an operation response is returned to the operator, respectively. In the example of FIG. 1, the operating device UIF has two types of operation interface units, and this is for the purpose of achieving both of the fine reflection of the intension of the operator on the action of the working machine ACT and the easy operation of the working machine ACT. The operation interface unit UIDP is suitable for control regarding the entire working machine ACT, and is implemented by using a display, a keyboard, a pointing device, and others. The operation interface unit UIPS is suitable for causing the working machine ACT to perform complex control of a part of the working machine ACT, in particular, the movable unit, and is implemented by using image information, a sensor, and others.

Details of communications between the operating device UIF and the working machine ACT are as follows. Operation instruction information AREQ is information for making an instruction about an action of the working machine ACT, and includes information regarding an action content of the working machine ACT and physical information such as the position and shape of the working machine ACT. Also, response information ARES from the working machine ACT includes information obtained from the sensor mounted on the working machine ACT (such as image information indicating an action situation, distance information for a supplement to a relative positional relation between the working machine and a target object and tactile information) and information regarding success or failure of the operation.

Communication means between the operating device UIF and the working machine ACT is not limited. For example, any medium such as wired or wireless may be used, and any connection configuration such as a direct connection or a connection via an external network may be used. However, in the case of a connection via an external network, a communication delay between the operating device UIF and the working machine ACT may be large, and in order to conceal this communication delay and prevent a decrease in operability, the operating device UIF is provided with the operation simulator UISM.

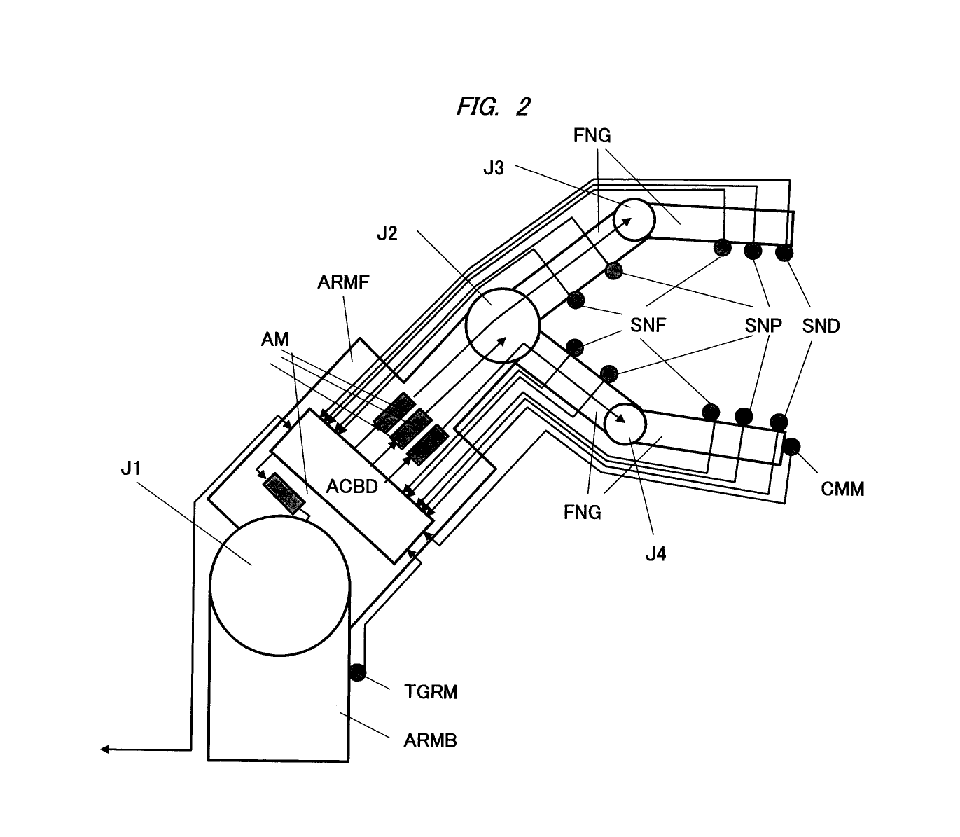

As an example of the working machine ACT, FIG. 2 shows the case in which the working machine ACT is a manipulator. Parts except a part represented as the working machine control unit ACBD correspond to the working machine movable unit ACMC shown in FIG. 1. The working machine movable unit ACMC has a base ARMB of the manipulator, an upper arm ARMF connected to the base ARMB via a joint J1, and fingers FNG of the manipulator connected at the tip of the upper arm ARMF via joints J2 to J4. A part made up of the four fingers FNG is referred to as a hand. Various sensors are attached to the fingers FNG. SNP is a pressure sensor, SNF is a slide sensor, SND is a distance sensor, CMM is an image sensor, and these sensors are connected to the working machine control unit ACBD. These sensors measure a relation between an operation target object (not shown) and the working machine ACT. Note that the slide sensor SNF is a sensor that detects whether an object is sliding over the working machine, and the one that detects a shear force generated on a surface of the working machine to detect a slide from a change of that force corresponds thereto. Owing to the slide sensor, a process of grabbing an object with a force not too strong but strong enough to prevent the object from sliding is possible, and various objects whose weight, coefficient of friction, and shape are unknown can be grabbed without being broken.

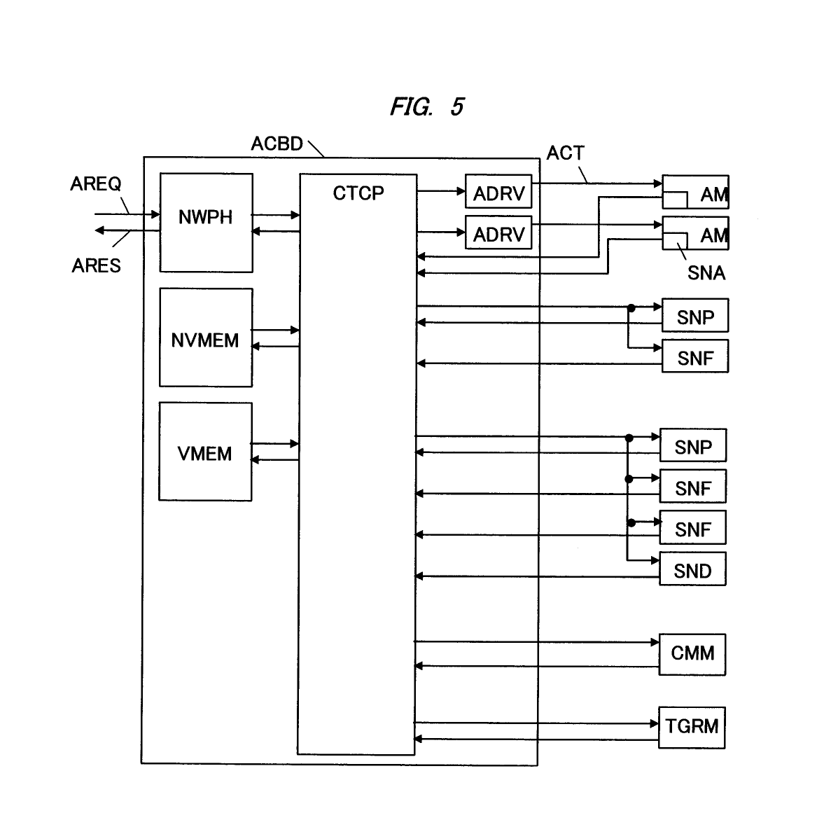

Also, TGRM is a tag reader module that reads information from a tag attached to the operation target object, and is connected to the working machine control unit ACBD. Also, AM is a motor for driving the joints, and is connected to the working machine control unit ACBD. These motors have a function of obtaining angle information (motor angle sensor SNA in FIG. 5), and this angle information is transmitted to the working machine control unit ACBD. The working machine control unit ACBD performs a computation with using the information from various sensors and the operating device UIF as inputs, and generates control information to the motors AM and information to the operating device UIF.

One feature of the working machine ACT is a two-step control structure in which while the working machine is controlled based on an action instruction such as rough position/shape (displacement of parts) information from the operating device UIF, the working machine ACT autonomously performs delicate power control required for the case of, for example, grabbing an object. The main body that performs this autonomous action control is the working machine control unit ACBD. For delicate power control, the force to be given to the operation target object has to be controlled in accordance with an action content such as grabbing and lifting or crushing. For this purpose, the working machine control unit ACED has a plurality of control programs in accordance with action contents and further has a connection to a sensor that observes a relation between the operation target object and the working machine ACT.

As described above, owing to the two-step control structure, a smooth operation is possible. If the working machine ACT does not autonomously perform the action control, the conditions that visual information and tactile information on the working machine side are given to the operator HMN with sufficient quality/quantity and a small delay time and a response until reflection on actuation of the working machine ACT is performed at high speed have to be satisfied for the smooth operation. However, it is in many cases difficult to satisfy all of the conditions. For example, when the operating device UIF and the working machine ACT are away from each other and the communication delay is large, it is difficult to satisfy the conditions described above. Also, the operating device capable of giving visual information and tactile information with sufficient quality/quantity is unrealistic in view of size and cost in many cases, and it is difficult to satisfy the conditions also in such a case. Conversely, if an operation by the operator HMN is not carried out, the working machine is required to autonomously perform all of the recognitions and determinations, but operations in an environment such as at home are very complex and have many technical difficulties.

In the embodiment shown in FIG. 1, in addition to this two-step control structure, the operation simulator UISM for returning an operation response such as images and tactile information on the working machine side to the operator HMN in a small delay time is provided. In the situation in which the communication delay time between the operating device UIF and the working machine ACT is large (for example, when the working machine ACT and the operating device UIF are connected via an external network), provision of both of these is effective for the smooth operation. Under these circumstances, if the operation simulator UISM is not provided, a response time from the time when the operator HMN operates until the time when the operation result is presented to the operator is prolonged, and only an operation at slow speed is possible. Furthermore, if the two-step control is not provided, delicate control is difficult. This is because it is difficult to present information with fine accuracy to the operator based on the images and tactile information obtained by using the results of the operation simulator UISM. For this reason, when both of the two-step control structure and the operation simulator are provided, it is possible to perform an operation with suppressing the adverse influence due to the communication delay time between the operating device UIF and the working machine ACT.

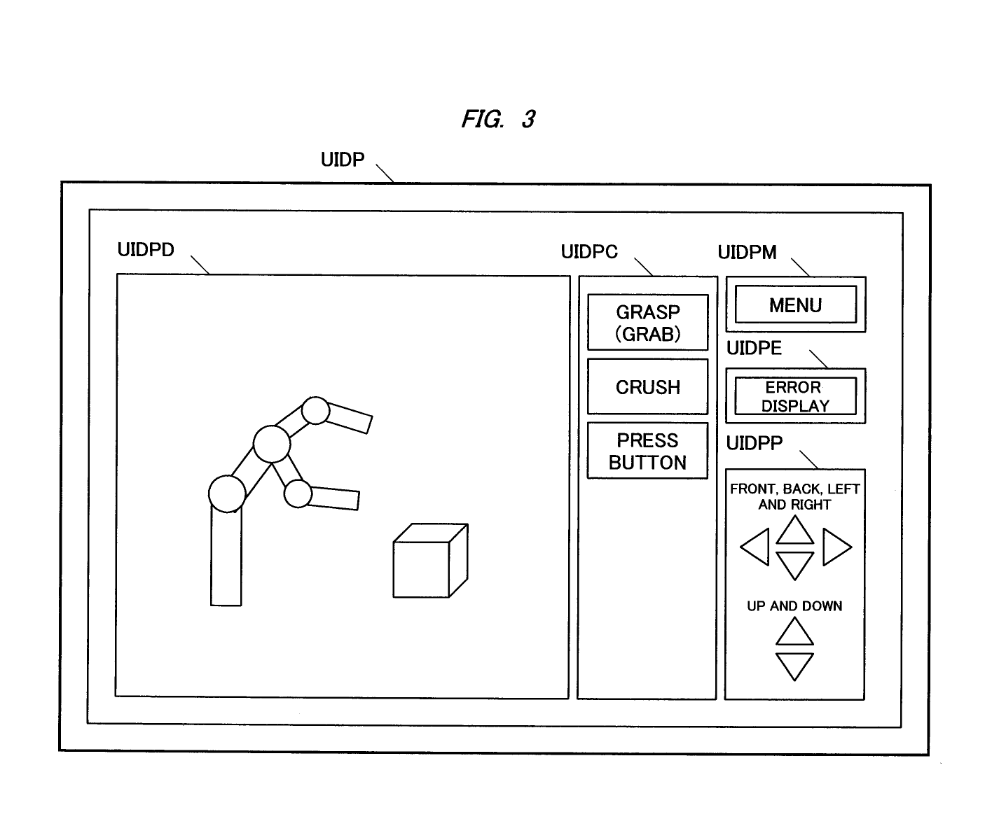

FIG. 3 shows a display example of a touch-panel-type display for use in the operation interface unit UIDP. In FIG. 3, the display includes an image display part UIDPD showing the action state of the working machine ACT, a part UIDPC in which the operator HMN makes an instruction about an action content, a part UIDPM for displaying others such as a menu, a part UIDPE showing error display when the operation fails, and a part UIDPP for making an instruction about a position of the entire working machine ACT. The display part UIDPC and the display part UIDPP correspond to the input part UIDPI shown in FIG. 1, and the display part UIDPD and the display part UIDPE correspond to the responding part UIDPO shown in FIG. 1.

The instruction part UIDPC has individual areas corresponding to action contents such as “GRASP”, “CRUSH”, and “PRESS BUTTON”, and the operator HMN presses an area corresponding to the action content desired to be performed by the working machine ACT, thereby making an instruction about the action content to the working machine ACT. Here, the action contents are varied for each user, and in order to easily provide actions of the working machine suitable for the user, implementation of the instructing part UIDPC is made with a touch panel. By updating an action program in accordance with the action content for the working machine ACT and a program of the operating device UIF for causing the working machine ACT to perform a predetermined action program, the user can easily increase and decrease the action contents and perform customization. As a matter of course, an operation interface provided with a dedicated button for a specific action content is also possible.

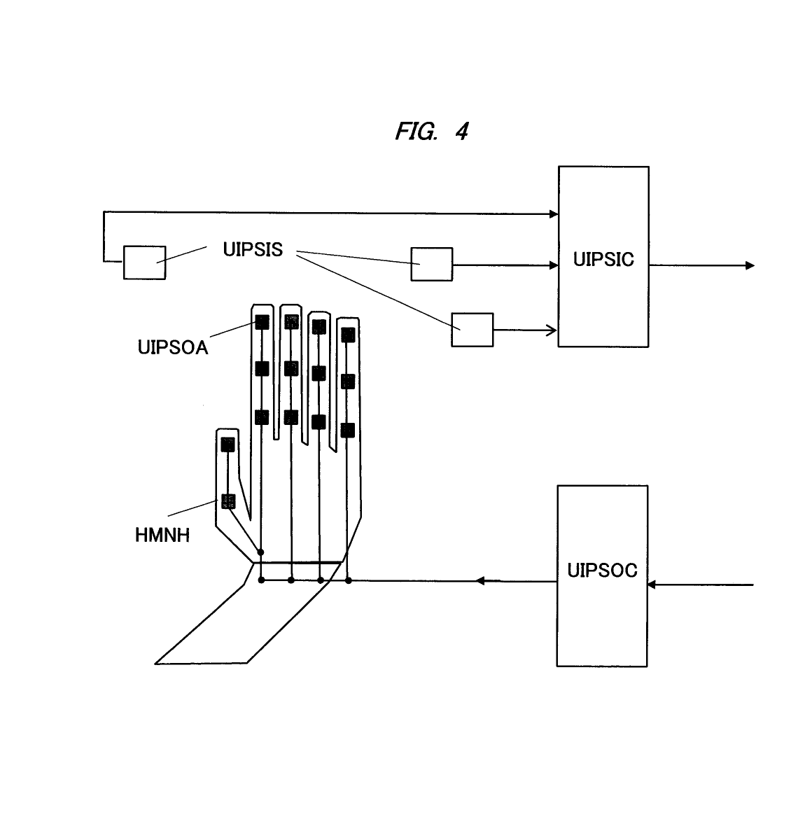

FIG. 4 shows an embodiment of the operation interface unit UIPS. On the assumption that the working machine ACT is a manipulator, an angle, position, and shape (angle of joint) of a hand part of the manipulator are inputted in this example of the operation interface unit. In the example of FIG. 4, these pieces of information are obtained by measuring a motion of the hand of the operator HMN. In this document, information obtained by this operation interface unit UIPS is referred to as a shape displacement target value. The operation interface unit UIPS is configured to detect a motion of the hand of the operator from the image information and output tactile information to the operator. A camera module UIPSIS is provided to detect a motion of the hand, and a shape calculating unit UIPSIC calculates a displacement of each part of the working machine ACT based on the image information obtained from the camera module UIPSIS. The shape displacement target value is outputted to the operation simulator UISM and/or the transmitting unit UIPT. The camera module UIPSIS and the shape calculating unit UIPSIC correspond to the input unit UIPSI shown in FIG. 1. This operation interface unit is not limited to this example using image information, and can be achieved by using, for example, an acceleration sensor, an angular velocity sensor, or the like placed so as to sense a motion of fingers of the hand.

Also, UIPSOA is an oscillation device for giving tactile information to a hand HMNH of the operator HMN, and UIPSOC is a control unit controlling the oscillation device UIPSOA based on the results of the operation simulator UISM or response information ARES received by the receiving unit UIPR (they are switched by an operation program).

A feature of this operating device UIF is that the means UIDPC for making an instruction about an action content, the means UIDPP for making an instruction about a position of the entire working machine, and the means UIPS for making an instruction about a shape displacement target value of a main control target part of the working machine are provided. While the working machine ACT of the present invention has a function of autonomously performing fine adjustment regarding the power and position based on the action contents, it is advantageous to provide the means for making an instruction about an action content separately from the means for making an instruction about a position and shape displacement in view of a load on the system or operability. If the means for making an instruction about an action content is not provided independently, the action content is required to be estimated and recognized from the means for making an instruction about the displacement. In this case, however, since there is a high possibility of increasing process load on the system and there is also a sufficient possibility of an erroneous action due to erroneous recognition, it will be a cause of giving a stress to the operator. In addition to simply providing the user interfaces for the operator HMN separately, these are achieved by different program modules in implementation, or even in the case of the same program module, these are reflected by varying parameters to be applied to the working machine ACT (for example, an upper limit value of an allowable displacement defined in advance). For example, in the case of using different program modules for each of instruction content units (for example, “grasp” and “crush”) of the instructing part UIDPC or even in the case of using a common program module for “grasp” and “crush”, for example, by providing different restrictions on the force and displacement amount to be applied to the operation target object or providing different restrictions on the motion of the hand, different restrictions are provided on the actions that the working machine ACT can take, whereby the operation in line with the intention of the operator HMN can be more easily achieved.

Furthermore, it is desirable that the means for making an instruction about a position of the entire working machine and an entire shape and the means for making an instruction about a displacement (shape displacement) of a main control target movable part of the working machine are also independently provided. This is because when the case in which the operator performs operation while sitting on a chair or the like and the working machine moves is taken into consideration, it is difficult to make both of an instruction about a large displacement of the movement of the entire working machine and an instruction about a fine displacement regarding the shape of the part of the working machine by one means. In the present embodiment, the operation interface unit UIDP makes an instruction about the position and shape of the entire working machine, and the operation interface unit UIPS makes an instruction about the displacement of the part of the working machine. The shape displacement target value outputted from the operation interface unit UIPS is a value for making an instruction about the displacement of the part of the working machine, and it is given to the working machine ACT as a parameter (target value) indicating an action amount of a program module for each instruction content unit of the instructing part UIDPC. Control from the operation interface unit UIPS does not involve the entire control, and is specialized in the control of the movable unit (for example, a tip part ahead of the joint J1 of FIG. 2) of the main control target part, so that the working action of the working machine ACT is stabilized.

FIG. 5 shows the configuration of the working machine control unit ACBD and a connecting relation between the motor AM, various sensors (pressure sensor SNP, slide sensor SNF, distance sensor SND, image sensor CMM, and motor angle sensor SNA) , the tag reader TGRM and others and the control unit ACBD. The working machine control unit ACBD is made up of a control LSI chip CTCP including a control processor and a memory for loading a program code in accordance with the operation content, a driver module ADRV driving an actuator such as a motor, a chip NWPH for performing communication with the operating device UIF, a non-volatile memory chip NVMEM such as a flash memory, and a RAM chip VMEM such as a DRAM. SNA is a sensor outputting information regarding the rotation angle of the motor. Also, a program for operating the working machine ACT is registered in the non-volatile chip NVMEM.

A feature of this configuration is that action information of the working machine itself such as rotation angle information SDA of the motor from the sensor SNA, sensor information indicating a relation between the working machine and the operation target object (information from the pressure sensor SNP, the slide sensor SNF, the distance sensor SND, and the image sensor CMM) , an operation instruction from the operating device UIF, and others are inputted to one control chip CTCP, a control signal for driving the motor is calculated based on these pieces of information, and a motor control signal ACT is outputted. By collecting control processes to one chip, a delay time from the inputs of the action information of the working machine itself and the sensor information indicating the relation between the working machine and the outside of the working machine to the motor control can be decreased, and the operation speed can be improved.

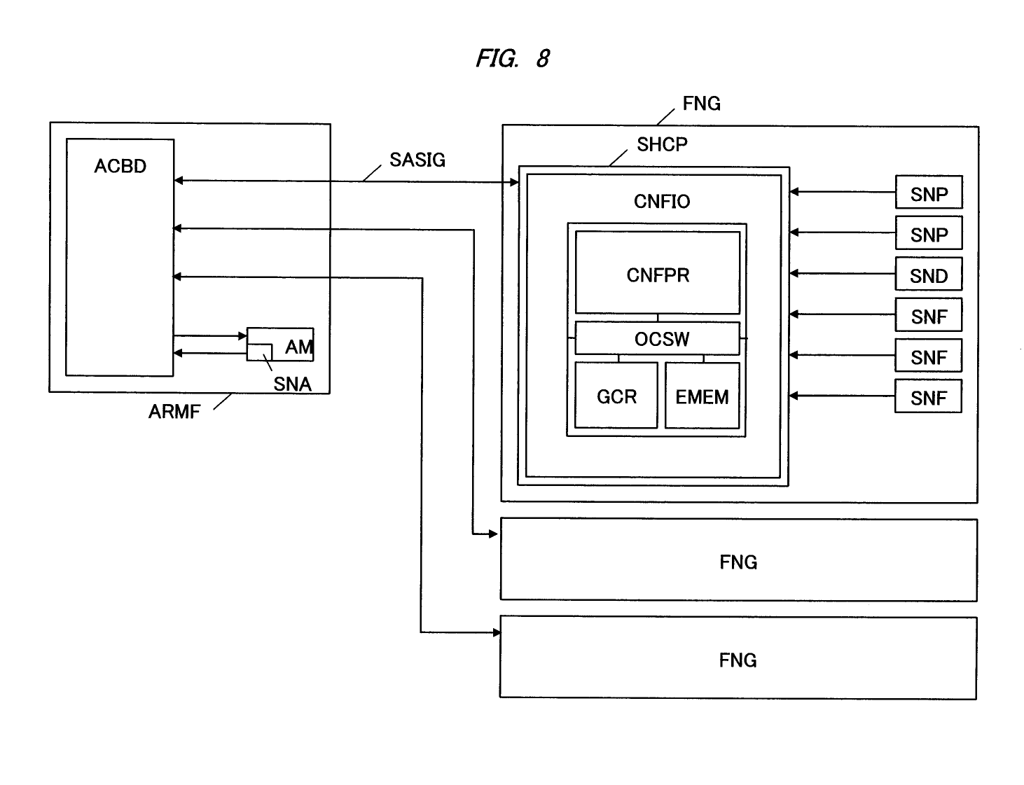

FIG. 8 shows another embodiment of the connection between the working machine control unit ACBD and a sensor mounted on the working machine ACT. A working machine of a manipulator type similar to that of FIG. 2 is shown. In order to cause the manipulator to make a delicate action, a plurality of sensors of various types are required to be mounted on a finger part. On the other hand, for the reduction in size and the high-speed action, the weight of the finger part is required to be made lighter, and the number of signal lines between the sensor of the finger part and the working machine control unit is required to be decreased.

In FIG. 8, a plurality of sensors (SNP, SND, SNF) of the finger part FNG are connected to the working machine control unit ACBD via a sensor connection chip SHCP. The sensor connection chip SHCP collects pieces of information from the plurality of sensors and transmits sensor information to the working machine control unit ACED via a set of signal lines SASIG. By forming the hierarchical connection topology in this manner, the working machine control unit ACBD and the sensors can be connected with a small number of signal lines. Also, in the embodiment of FIG. 8, the reason why the sensors and the sensor connection chip are mounted on the finger part FNG and the working machine control unit ACED and the actuator (motor AM) are mounted on the upper arm ARMF is to achieve the weight reduction of the finger part FNG where a delicate action is required.

The sensor connection chip SHCP is made up of a configurable IO circuit CONFIO for connecting various sensor elements, a configurable digital processing circuit CNFPR such as a FPGA (Field Programmable Gate Array), a general-purpose digital processing circuit GCR including a general-purpose processor, timer and others, an on-chip memory EMEM, and an on-chip switch fabric circuit OCSW for connecting these to perform signal transmission.

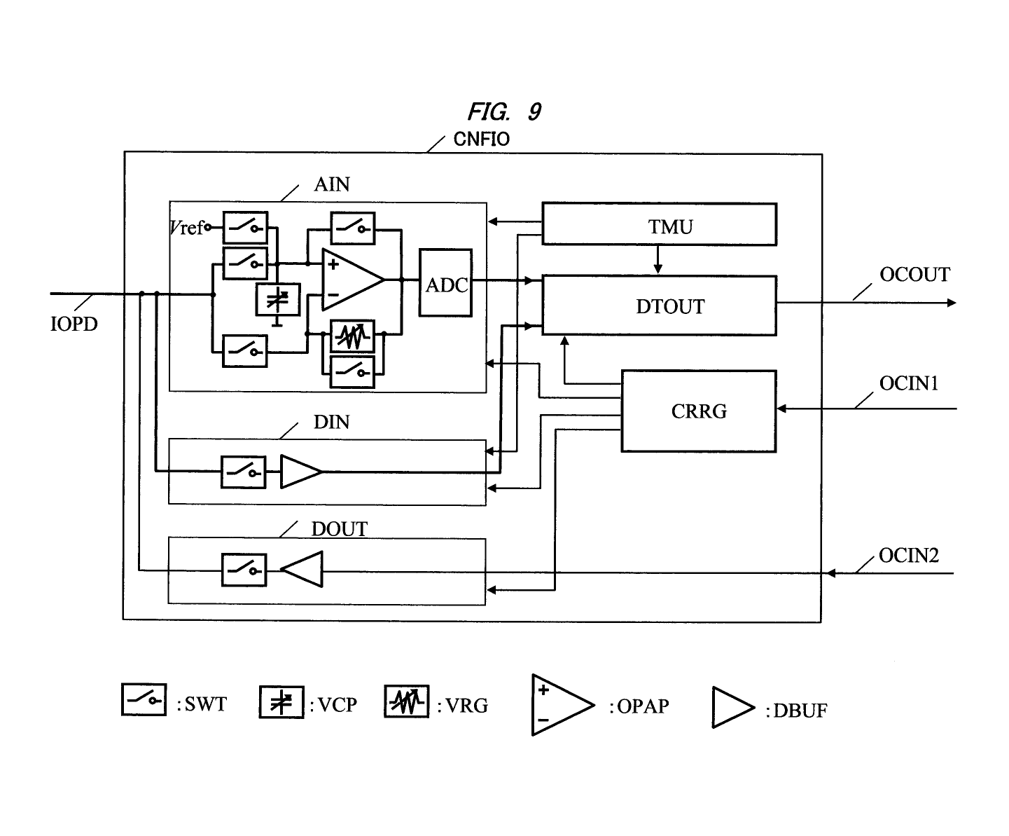

FIG. 9 shows an example of configuration of the configurable IO circuit CONFIO. An analog input circuit AIN is a circuit block that processes analog input information from outside of the chip, a digital input circuit DIN is a circuit block that processes a digital input from outside of the chip, and a digital output circuit DOUT is a circuit block that outputs digital information from inside of the chip to outside. Also, an on-chip data output port circuit DTOUT is a circuit block for outputting information from the analog input circuit AIN and the digital input circuit DIN to the on-chip switch fabric OCSW, and a configuration register CRRG is a circuit block including a storage element for setting configuration information of the analog input circuit AIN, the digital input circuit DIN, the digital output circuit DOUT, and the on-chip data output port circuit DTOUT. A timer TMU is a timer circuit block that generates a timing for obtaining information from each sensor. The on-chip data output port circuit DTOUT has a role of obtaining data from a circuit (selected from the analog input circuit AIN and the digital input circuit DIN) whose connection is specified by the configuration register CRRG at the timing specified by the timer TMU and transmitting the data in synchronization with a clock of the on-chip switch fabric circuit OCSW. While one analog input circuit AIN and one digital input circuit DIN are connected to one on-chip data output port circuit DTOUT in this drawing, the ratio of the number of circuits is not limited to this. Also, a signal IOPD is a signal to be coupled to an input/output terminal connected to the outside of the chip, and a signal OCOUT, a signal OCIN1, and a signal OCIN2 are signals to be coupled to the on-chip switch fabric circuit OCSW.

The analog input circuit AIN is a circuit block enabling the connections of sensors having various outputs such as a resistance value, a capacitance value, and an analog voltage value. The analog input circuit AIN includes an operational amplifying circuit OPAP, an AD conversion circuit ADC, a variable resistor VRG, a variable capacitor VCP, and a switch circuit SWT for changing the connection configuration of these circuits. Vref is a reference voltage. Since the amplifying circuit OPAP, the variable resistor VRG, and the AD conversion circuit ADC are provided, a variable-resistor-type sensor which outputs a sensing value as a resistance value without having an amplifying circuit inside the sensor can be connected with a minimum number of chips. Also, since the amplifying circuit OPAP, the variable capacitor VCP, and the AD conversion circuit ADC are provided, a variable-capacitor-type sensor which outputs a sensing value as a capacitance value without having an amplifying circuit inside the sensor can be connected with a minimum number of chips. As described above, since the AD conversion circuit ADC is provided, a sensor which outputs a sensing value as an analog voltage value can be connected with a minimum number of chips.

The digital input circuit DIN and the digital output circuit DOUT each includes a digital buffer circuit DBUF and a switch circuit SWT.

The configuration information of the configuration register CRRG includes ON/OFF of the switch circuit SWT included in the digital input circuit AIN, a resistance value of the variable resistor VRG, information for specifying a capacitance value of the variable capacitor VCP, information for specifying ON/OFF of the switch circuit SWT of the digital input circuit DIN, and information for specifying ON/OFF of the switch circuit SWT of the digital output circuit DOUT.

As described above, since the sensor connection chip has the configurable IO circuit CONFIO, sensors having various outputs such as a resistance value, a capacitance value, an analog voltage value, and a digital voltage value can be connected with a minimum number of chips, and the weight of the finger part can be made lighter.

A typical process of the sensor connection chip is as follows.

(1) Information from the sensors are taken into the sensor connection chip SHCP. This process is executed by the configurable IO circuit CNFIO. The configurable IO circuit CNFIO samples information of the sensors at time intervals set in advance, and retains the information as a digital value. The configurable IO circuit CNFIO has the timer circuit (TMU) for making an instruction about a sampling timing.

(2) The information obtained by the configurable IO circuit CNFIO is subjected to digital computation process and is converted to sensing information to be transmitted to the working machine control unit ACBD. One of digital process contents is a noise removing process for the sensor information obtained by the configurable IO circuit CNFIO, and filtering process or the like is performed. Also, when the information obtained by the configurable IO circuit CNFIO contains information such as a header other than the sensing information, a process of extracting the sensing information except the header and others is also performed. Also, necessary sensing information is produced in some cases by performing the predetermined computation to the information obtained by the configurable IO circuit CNFIO. In that case, a converting process is also performed. These processes are performed by the configurable digital processing circuit CNFPR or the general-purpose digital processing circuit GCR. Since the sensor connection chip SHCP includes a configurable digital processing circuit such as the FPGA, process contents such as the filtering process can be changed after manufacture, and both the optimization of performance in accordance with the product and the use state and the increase in process speed can be achieved.

(3) To the sensing information processed in (2) described above, a coding process computation for error tolerance for tolerating noises occurring on a transmission path (between the sensor connection chip SHCP and the working machine control unit ACBD) is performed. Since the sensor connection chip includes a configurable digital processing circuit such as the FPGA, the process content can be changed after manufacture, and both the application of the coding method for error tolerance in accordance with the product and the use state and the increase in process speed can be achieved.

(4) The sensing information processed in (3) described above is transmitted to the working machine control unit ACBD. A communication circuit for performing communications with the working machine control unit ACBD is formed in a part of the configurable digital processing circuit CNFPR in advance.

Through the flow as described above, the information obtained from the sensors is transmitted to the working machine control unit ACBD.

Also, in the configuration shown in FIG. 8, one feature is that a signal line SASIG between the sensor connection chip SHCP and the working machine control unit ACBD is used in a time division manner for both of the transmission of the setting information (sensor configuration information and programs) from the working machine control unit ACBD to the sensor connection chip SHCP and the transmission of the sensing information from the sensor connection chip SHCP to the working machine control unit ACBD. At the time of initialization of the working machine, circuitry settings (such as an input/output direction) regarding the signal line SASIG of the control chip CTCP and the sensor connection chip SHCP are made so that transmission of the setting information from the working machine control unit ACBD to the sensor connection chip SHCP can be performed via the signal line SASIG. After initialization is completed, circuitry settings (such as an input/output direction) regarding the signal line SASIG of the control chip CTCP and the sensor connection chip SHCP are changed so that transmission of the sensing information from the sensor connection chip SHCP to the working machine control unit ACBD can be performed via the signal line SASIG. In this manner, both of the reduction in weight of the finger FNG part of FIG. 8 and the reduction in the number of signal lines between the sensor connection chip SHCP and the working machine control unit ACBD can be achieved.

As described above, by forming a tree-type connection topology using the sensor connection chip, reduction in the number of sensor signal lines to be connected to the working machine control unit ACBD can be achieved. Also, by the implementation using the sensor connection chip SHCP including the sensor configurable IO circuit CNFIO, reduction in weight of the movable unit where a delicate action is required can be achieved.

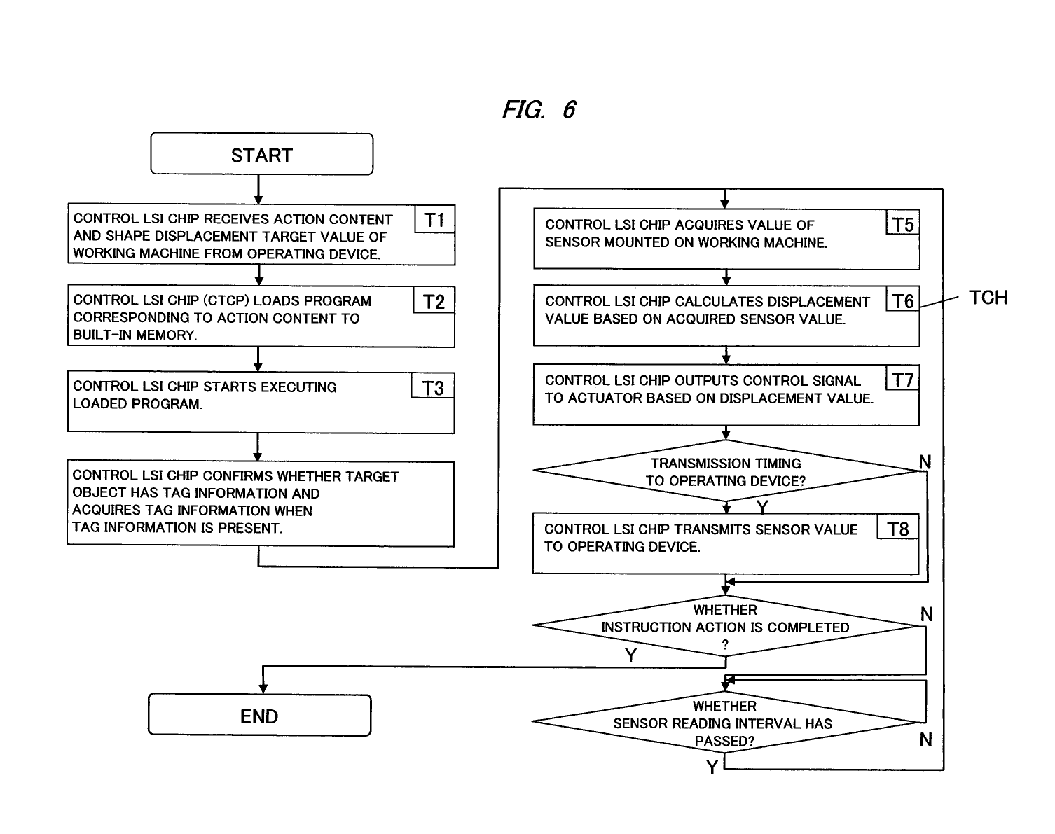

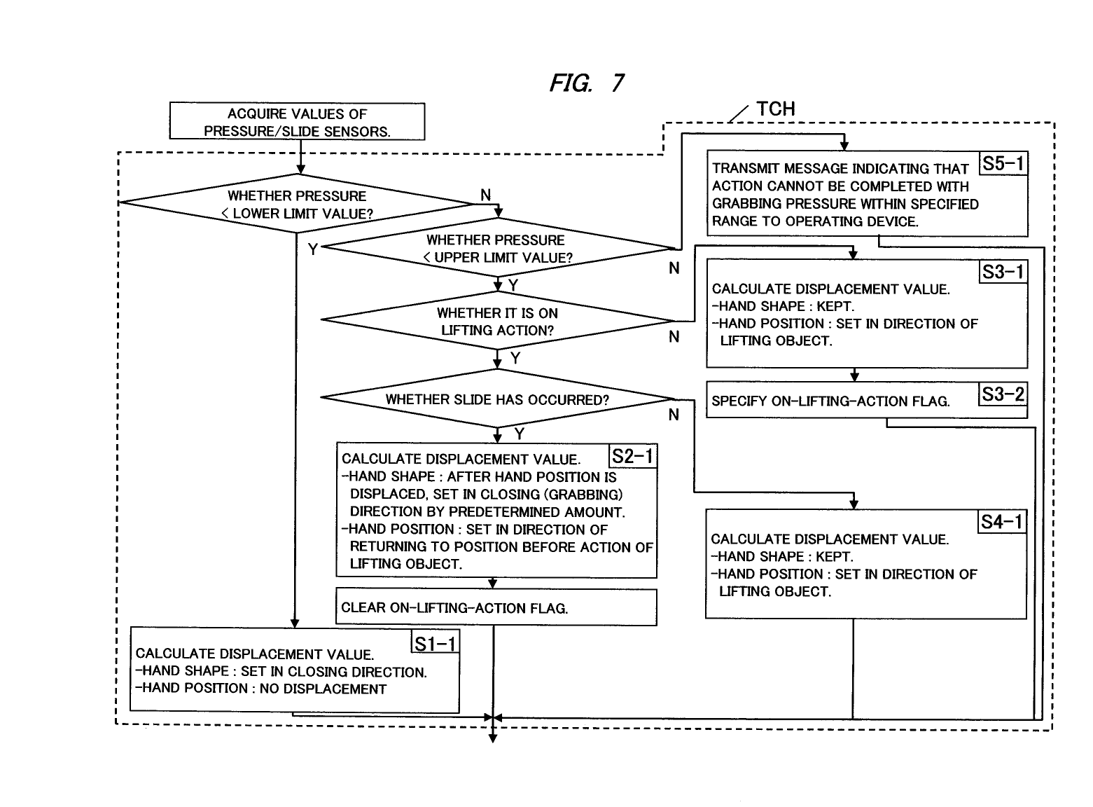

The working machine ACT performs an action in which the instruction form the operator HMN via the operating device UIF and an autonomous action using the sensing information from the sensors mounted on the working machine ACT are combined. The process flow thereof taking a manipulator as an example is shown in FIG. 6 and FIG. 7.

Firstly, the position of the entire working machine ACT is operated. Although details are omitted, the position of the entire working machine ACT is operated by using the operation interface unit UIDP. A movement instruction in accordance with the instruction about a movement direction by the operator HMN is transmitted to the working machine ACT, and an entire position operation program module is executed in the working machine control unit ACBD. More specifically, in response to the movement instruction, the working machine ACT moves to front, back, left, and right or changes its height vertically.

A general outline of a flow of a subsequent process regarding control of a main control target part of the working machine ACT is described with reference to FIG. 6. In the example shown in FIG. 2, FIG. 3, and FIG. 4, a tip part ahead of the joint J1 shown in FIG. 2 corresponds to the main control target part of the working machine ACT mentioned here.

First, the working machine ACT receives an action content of the working machine and a shape displacement target value from the operating device UIF (T1). The shape displacement target value is information obtained via the operation interface unit UIPS shown in FIG. 4, and is information for making an instruction on how the angle, position, and shape of the hand are changed in the present embodiment (in other words, information about the initial angle, position, and shape of the hand and how the actuator is moved).

Next, the working machine ACT loads a control program corresponding to the received action content from the non-volatile memory NVMEM in the working machine control unit ACBD to the memory in the control chip CTCP (T2) . In the non-volatile memory NVMEM, a plurality of program modules corresponding to a plurality of action contents are stored, and the one corresponding to the action content is selectively loaded therefrom. The reason why the control program is loaded to the memory in the control chip is to execute the control program in a shorter time.

After the loading is completed, execution of the loaded control program is started (T3). At step T4, if the target has a tag, a process of obtaining its tag information is performed. This tag information includes auxiliary information useful for operating an object such as a pressure at the time of grabbing the object and a position to be grabbed. When the operation target object has a tag including information about itself as described above, the working machine reads information from the tag, and the working machine ACT uses the read information for autonomous power control and fine adjustment of the position.

In the control program of the present embodiment, at step T5 and thereafter, information is continuously obtained from the sensors (pressure sensor SNP, slide sensor SNF, image sensor SND, and motor angle sensor SNA) mounted on the working machine ACT for each predetermined sensor reading interval (T5). In the working machine ACT, an actual displacement value is calculated from the sensor values and the action content and the shape displacement target value instructed from the operating device UIF (T6), and based on the displacement value, a control signal for driving the actuator is outputted (T7). This operation is repeated until the action instructed from the operating device UIF is completed. Also, at step 8 (T8), the obtained sensing data is transmitted at a predetermined timing to the operating device UIF.

Next, the process at step T6 in FIG. 6, that is, “the process of calculating a displacement value based on the obtained sensor values” is described. By way of example, a process of causing the working machine ACT to lift an object is described. In this case, precision control using values mainly from the pressure sensor SNP and the slide sensor SNF mounted on the working machine ACT is performed.

The operator HMN performs operation with the use of the operating device while checking a relation between the operation target object and the hand by sight directly or through the display UIDPD. In this example of lifting the object, the operator HMN makes an instruction for an action content of lifting the object by using the operation interface UIDP, and then makes an instruction for a shape displacement target value regarding a series of actions of moving the hand of the working machine ACT (determining an initial position and angle), closing the hand to grab the object, and lifting the object by using the operation interface unit UIPS. Upon receiving the instruction, the working machine ACT sets a target value and a restriction value of the action of each part of the movable unit of the working machine ACT based on the operation content and the shape displacement target value, calculates a displacement value in accordance with these values and the sensing value, and changes the shape of the hand. The target value and the restriction value of the action vary depending on each of phases of moving the hand, closing the hand, and lifting.

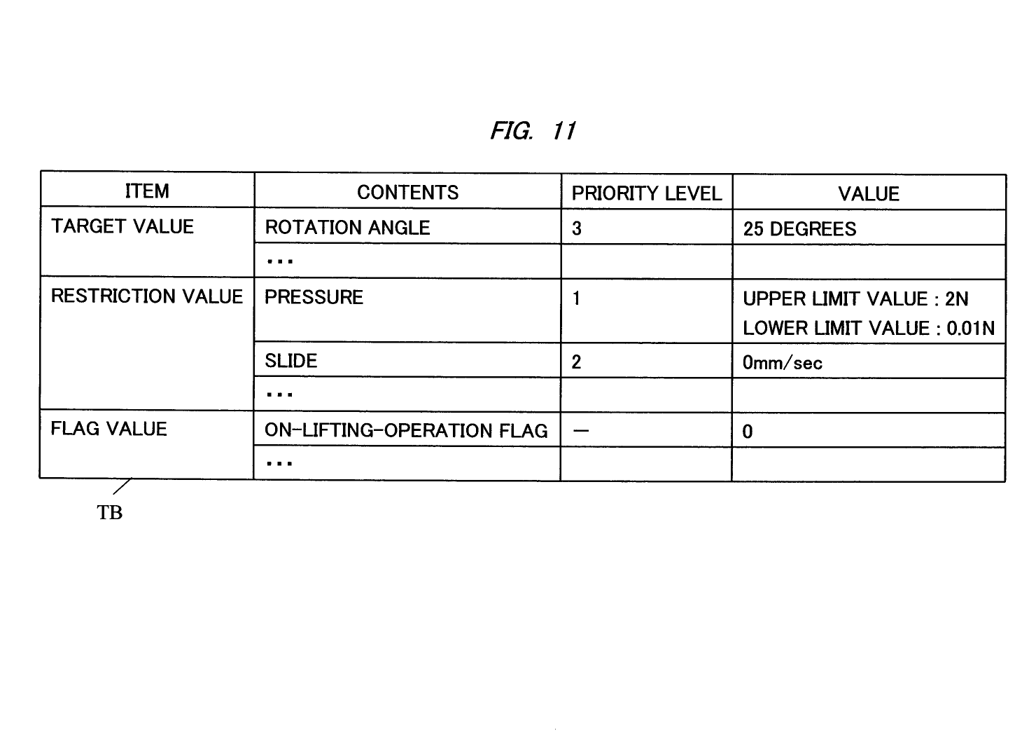

FIG. 11 shows an example of a table TB indicating target values and restriction values of actions of the finger FNG linked to the joint J3 in the phase of closing the hand. In this example, the table TB contains target values, restriction values, and flag data. The target values include a rotation angle value of the joint J3, and the restriction values include pressure values (upper limit and lower limit values) allowable for the finger FNG linked to the joint J3 and a slide value between the finger FNG linked to the joint J3 and the target object. The flag is set according to the need of the control, and a flag indicating “on lifting action” is set in this example. Also, a priority level is given to each item of the action restriction values. Note that the target values and the restriction values are determined from the action content and the shape displacement target value in some cases, or given from the operation content, the shape displacement target value, and tag information obtained from the tag attached to the operation target object in other cases. While the action of the movable unit (hand) of the working machine ACT is being controlled, each mounted sensor performs sensing (step T6), and the working machine control unit ACBD compares the sensing information and the values on the table TB. In the example of FIG. 11, a priority level is given to each of the target values and the restriction values, and an item with a higher priority level (smaller value) is prioritized. In the phase of closing the hand, the finger FNG is first controlled toward the rotation angle of the action target value. However, even if the finger does not reach the position target, the closing action is completed when the restriction values are satisfied, and the position of the finger FNG is determined.

A flow of the process at step T6 in FIG. 6, that is, “the process of calculating a displacement value based on the obtained sensor values” is described with reference to FIG. 7. As with the above, a process of causing the working machine ACT to lift an object by mainly using the pressure sensor SNP and the slide sensor SNF is taken as an example.

Firstly, the position and angle of the hand are determined from the shape displacement target value instructed from the operation interface unit UIPS and the tag information. This phase of “moving the hand” is not shown in FIG. 7.

Subsequently, the procedure makes a transition to the phase of “closing the hand to grab the object”. In order to grab the object, the working machine control unit ACBD operates the hand so as to close the hand (S1-1). This operation is repeated until the pressure sensor value of each movable unit exceeds a grabbing pressure lower limit value on the table TB.

When the pressure sensor value of each movable unit exceeds the grabbing pressure lower limit value on the table TB, the working machine control unit ACBD determines that the working machine ACT has touched the operation target object. The working machine control unit ACBD stores the position and state of the hand at this moment. Next, the working machine control unit ACBD attempts to lift the target object (S3-1 and S3-2). At step S3-1, while keeping parameters related to the shape of the hand, an action target value (displacement value) of each movable unit is set so that the position of the entire hand is raised. This means that the joint J1 is rotated in a direction of raising the hand position while keeping the angles of the joints J2, J3, and J4 in FIG. 2. At S3-2, at the next sensor read timing, a flag for storing the state that the machine is on a lifting action (on-lifting-action flag) is set. Also at this time, the working machine control unit ACBD stores the position of the hand and the shape of the hand before raising the hand position. After the sensor read time has elapsed after the series of operations at steps S3-1 and S3-2, the procedure makes a transition to control at step S2-1 or S4-1 in accordance with the value of the slide sensor SNF.

If no slide is detected at the lifting attempts at step S3-1 and S3-2, it is determined that the object has been successfully lifted, and the procedure makes a transition to the phase of “lifting the object”. Control for lifting the object is performed while keeping the hand shape as it is (step S4-1). For example, if the action target value is defined as an action angle of the joint J1 in accordance with the shape displacement target value instructed from the operation interface unit UIPS, step S4-1 is performed until the rotation angle of the motor driving the upper arm ARMF becomes equal to the action target value. When the action is completed, the on-lifting-action flag is also released.

On the other hand, if a slide of the object is detected as a result of lifting attempts at steps S3-1 and S3-2, the procedure makes a transition to a process at step S2-l. Since this means that the lifting attempts have failed, at step S2-1, the hand position is returned to the position before the attempt at step S3-1, and a displacement value of the hand shape is set so as to grab the object harder. This means that the angles of the joints J2, J3, and J4 are rotated in a direction of grabbing the object harder and the joint J1 is rotated in a direction of lowering the hand position in FIG. 2. At step S2-2, the on-lifting-action flag is released, and lifting attempts at steps S3-1 and S3-2 are performed again.

The lifting attempts are continued in this manner and when the pressure exceeds a pressure upper limit specified in advance, the procedure enters an exception process at step S5-1. In this case, in order to inform the operator that the lifting action cannot be completed with a grabbing pressure within a specified range, a message indicating it is transmitted to the operating device UIF, and an error display UIDPE is shown on the display screen.

As described above, in this process, by using the pressure sensor SNP and the slide sensor SNF mounted on the working machine ACT, the object is lifted with a minimum force capable of preventing the object from sliding. In this manner, even an object whose hardness and weight are unknown can be handled. By using the slide sensor, whether any of various objects is sliding can be instantaneously determined, and a delicate process can be performed at high speed.

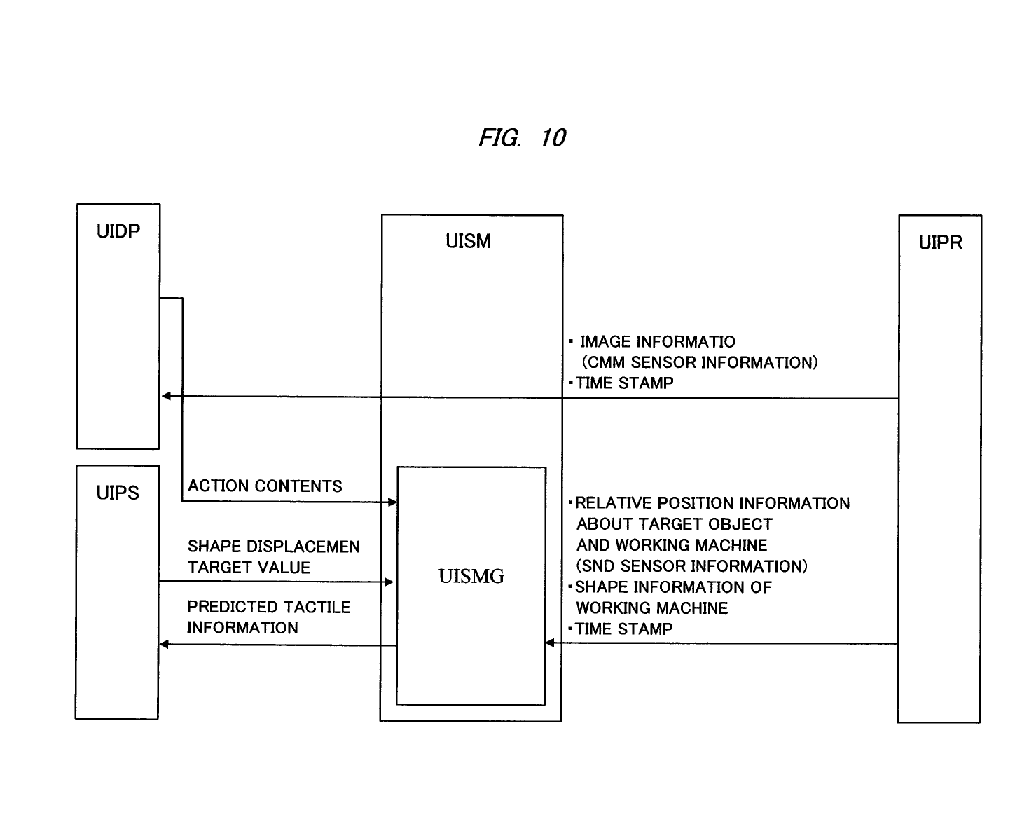

An embodiment of the operation simulator UISM of the operating device UIF is described with reference to FIG. 10. The operation simulator UISM shown in FIG. 10 calculates a timing when the working machine ACT makes contact with the operation target object, and transmits predicted tactile information to the operation interface unit UIPS. Based on this predicted tactile information, the operation interface unit UIPS gives tactile information to the operator.

In order to generate this tactile information, the operation simulator UISM uses action content instruction information from the operation interface unit UIDP, shape displacement target value from the operation interface unit UIPS, relative position information about the working machine and the target object from the working machine ACT, and the shape information of the working machine from the working machine ACT. The relative position information is information from the distance sensor SND mounted on the working machine, and is the information indicating a distance between each part of the hand and the target object.

A predicted tactile information generating unit UISMG of the operation simulator UISM has a model of the working machine. This model includes information such as a mechanical structure of the working machine, a mounting position of the distance sensor, an action algorithm (FIG. 6, FIG. 7 and others), characteristics of the actuator (action speeds in various cases), and others. From this model, the instruction information described above (the action content and the shape displacement target value), and the shape information of the working machine described above, an action speed of each part of the working machine is obtained, and from the calculated action speed information and relative position information, a timing when the working machine makes contact with the target object is obtained. As described above, what the operation simulator UISM simulates is an action in the case where ideal operation is performed based on the operation interfaces USDP and UIPS, and the simulation is not performed for the autonomous control of the working machine. In this manner, communication resources required for simulating autonomous control of the working machine are much saved.

Also, in the present embodiment, among the pieces of information to be fed back to the operator, the image information from the working machine is directly given to the operator, and only the tactile information is simulated. Since a human is more sensitive to feedback time of the tactile information, it is particularly important to conceal a delay of the tactile information. However, this does not mean that feedback of the image information is excluded.

With this operation simulator, even if a large delay is present between the operating device and the working machine, tactile feedback information can be given to the operator without delay, and smooth operation by the operator can be achieved.

With the series of invention matters, a smooth operation with small operator's stress can be achieved in a human-operated working machine.

### EXPLANATION OF REFERENCE SINGS

ACT: working machine, UIF: operating device, HMN: operator, UISM: operation simulator, ACBD: working machine control unit, ACMC: working machine movable unit, SNP: pressure sensor, SNF: slide sensor, SND: distance sensor, CMM: image sensor, TGRM: tag reader module, SNA: motor angle sensor, AM: motor, CTCP: control chip, SHCP: sensor connection chip

1. A working machine system having a working machine and an operating device for operating the working machine,
wherein the working machine comprises:
a movable unit;
a sensor mounted on the movable unit; and
a control unit controlling a motion of the movable unit, the operating device comprises:
a first operation interface unit making an instruction about an operation content to the working machine; and
a second operation interface unit making an instruction about a shape displacement target value of the movable unit of the working machine,
the control unit of the working machine controls the motion of the movable unit in accordance with a program corresponding to the operation content instructed by the first operation interface unit, and sets an action target value of the movable unit and an action restriction value of the movable unit in accordance with the shape displacement target value instructed by the second operation interface unit,
the sensor of the working machine performs sensing at predetermined read intervals, and transmits sensing information to the control unit of the working machine, and
the control unit of the working machine stops the motion of the movable unit when the sensing information exceeds the action restriction value even if the action target value has not yet been achieved.

2. The working machine system according to claim 1,
wherein a plurality of restriction conditions are included as the action restriction values, and a priority level is given to each of the plurality of restriction conditions.

3. The working machine system according to claim 1,
wherein the working machine further comprises a tag reader module reading tag information from a tag attached to an operation target object to be operated by the working machine, and
the action restriction value includes a restriction condition given in advance from the program and a restriction condition given from the tag information.

4. The working machine system according to claim 1,
wherein the working machine has a sensor connection chip,
the working machine has a plurality of sensors and the control unit of the working machine has a control chip performing a control computation, and
one said sensor connection chip is connected to the plurality of sensors, and one said control chip is connected to the plurality of sensor connection chips to which the plurality of sensors are connected.

5. The working machine system according to claim 4,
wherein the sensor connection chip has element circuits including an AD conversion circuit, an amplifying circuit, a variable resistor, a variable capacitor, and a switch circuit, and a memory storing a connecting relation of the element circuits and a value of the variable resistor and/or the variable capacitor, and
based on information stored in the memory, a conversion circuit is configured from the element circuits and analog sensing information from the sensor is converted to digital sensing information.

6. The working machine system according to claim 1,
wherein a slide sensor detecting whether an operation target object is sliding on a surface of the working machine is provided as the sensor.

7. A working machine system having a working machine and an operating device for operating the working machine,
wherein the working machine comprises:
a movable unit;
a sensor mounted on the movable unit; and
a control unit controlling a motion of the movable unit, the operating device comprises:
a first operation interface unit making an instruction about an operation content to the working machine;
a second operation interface unit making an instruction about a shape displacement target value of the movable unit of the working machine; and
an operation simulator simulating an action of the working machine,
the control unit of the working machine controls the motion of the movable unit in accordance with a program corresponding to the operation content instructed by the first operation interface unit, and sets an action target value of the movable unit and an action restriction value of the movable unit in accordance with the shape displacement target value instructed by the second operation interface unit,
the sensor of the working machine performs sensing at predetermined read intervals, and transmits sensing information to the control unit of the working machine,
the control unit of the working machine controls the movable unit with two types of control including control based on the instructions of the first and second operation interface units and autonomous control to be performed by comparing the sensing information and the action restriction value, and
the operation simulator has a model of the working machine, calculates an action speed of the movable unit of the working machine from the model and the instructions of the first and second operation interface units, calculates a timing when the working machine makes contact with a target object from relative position information of the working machine and the operation target object and the action speed, and feeds back the calculated values to the second operation interface unit.

8. The working machine system according to claim 7,
wherein the working machine and the operating device are connected via an external network.

9. The working machine system according to claim 7,
wherein the control unit of the working machine performs the control based on the instructions of the first and second operation interface units until the movable unit of the working machine makes contact with the target object.

10. The working machine system according to claim 7,
wherein the feedback is performed with tactile information to an operator.

11. The working machine system according to claim 7,
wherein a plurality of restriction conditions are included as the action restriction values, and a priority level is given to each of the plurality of restriction conditions.

12. The working machine system according to claim 7,
wherein the working machine further comprises a tag reader module reading tag information from a tag attached to an operation target object to be operated by the working machine, and
the action restriction value includes a restriction condition given in advance from the program and a restriction condition given from the tag information.

13. The working machine system according to claim 7,
wherein the working machine has a sensor connection chip,
the working machine has a plurality of sensors and the control unit of the working machine has a control chip performing a control computation, and
one said sensor connection chip is connected to the plurality of sensors, and one said control chip is connected to the plurality of sensor connection chips to which the plurality of sensors are connected.

14. The working machine system according to claim 13,
wherein the sensor connection chip has element circuits including an AD conversion circuit, an amplifying circuit, a variable resistor, a variable capacitor, and a switch circuit, and a memory storing a connecting relation of the element circuits and a value of the variable resistor and/or the variable capacitor, and
based on information stored in the memory, a conversion circuit is configured from the element circuits and analog sensing information from the sensor is converted to digital sensing information.

15. The working machine system according to claim 7,
wherein a slide sensor detecting whether an operation target object is sliding on a surface of the working machine is provided as the sensor.
